(19) United States
(12) Patent Application Publication
(10) Pub. No.: US 2024/0190518 A1
(43) Pub. Date: Jun. 13, 2024

(54) Tractor Bottom Guard Device

(71) Applicant: Joshua Wallmuth, Deville, LA (US)

(72) Inventor: Joshua Wallmuth, Deville, LA (US)

(21) Appl. No.: 18/583,720

(22) Filed: Feb. 21, 2024

(51) Int. Cl. B62D 25/20; B62D 49/00

(52) U.S. Cl. CPC B62D 25/2072; B62D 49/00

(57) ABSTRACT

A tractor bottom guard device is provided comprising a skid plate, an engine belly pan, and side shields removably connected to brackets, removably connected to an underside of a tractor. The skid plate includes a planar member and a diagonal wall disposed at a front end thereof, which is removably bolted to front corner guard brackets. The planar member is removably connected to transmission brackets that are bolted to the transmission of the tractor. A transversal plate extends upward from a rear end of the planar member, which is removably bolted to rear axle brackets. The disclosed brackets are bolted to the underside frame of the tractor, in alignment with the OEM factory bolt holes of the frame of the tractor. The bottom guard device defines apertures configured to provide easy access to underside OEM mechanical components of the tractor without requiring removal of the tractor bottom guard device.

### BACKGROUND OF THE INVENTION

### Field of the Invention

The present invention relates generally to tractors and more particularly to a guard device for enclosing the underside of a tractor to protect the underside mechanical components of the tractor against physical damage from the environment.

### Description of the Related Art

An undercarriage of a tractor refers to the set of components that support and propel the machine, including the tracks or wheels, and associated parts including, but not limited to, axles, links, pins, bushings, sprockets, rollers shoes, frames, and more. Additional vital components located at the bottom or underside of the tractor include a transmission system, gear boxes, fuel tanks, fuel lines, oil pans, electrical wiring, and a hydraulic system including hydraulic lines, hydraulic gear pumps to generate pressure in the hydraulic system, or hydraulic cylinders (aka RAM cylinders) to transmit fluid from the piston to the hydraulic arm. These such underside components of the tractor are vital to operation of the tractor but are exposed to the environment, and as such, are often easily damaged due to such unprotected components coming into contact with obstructions, such as tree stumps, branches or rocks, when traversing uneven road or ground surfaces during use of the tractors. Uneven terrain causes the underside components to frequently make impact with the obstructions due to a lack of sufficient protection, and as such, these vital components of tractors are exposed to hazards and are damaged, giving rise to expensive repairs and costly downtime of the tractor. Such impacts with obstructions also shorten the overall lifespan of the tractor. The repairs can be time-consuming and expensive, causing a financial burden for tractors owners and operators.

None of the existing solutions provide a convenient, effective, and efficient way to enclose and protect underside components of the tractors.

A need also exists for a bottom protection device that can be used as an aftermarket product and that addresses the lack of protection of underside components. Further, a need exists for a new protection device that is easy to attach to and detach from the underside of a tractor, to provide protection to vital components while providing access to service components of the tractor.

Conventional undersides of tractors do not provide protection against damage to key components such as oil pans, fuel tanks, hydraulic lines, and electrical wiring and the like; and of the few integrated protection devices in existence, none of such devices disclose the unique structures and advantages of the present disclosure of protecting and enclosing the critical underside components.

Accordingly, there is a need for a protection device for the undersides of tractors that effectively covers and protects the critical and vulnerable underside components and is that easy to manufacture and cost-efficient for tractor owners and operators.

It is one prospect of the present invention to provide novel tractor underside protection devices of simple but effective construction for convenient and efficient enclosure of the underside for protection of its vital components against damages from the environment.

It is another prospect of the disclosed invention that avoids and overcomes many of the drawbacks of existing devices.

Another object of the present invention is to provide a skid plate that can be detachably connected to the underside of an OEM frame of a tractor.

Yet another object of the disclosed invention is to provide attachable tractor bottom guard devices that protect the vital parts of the tractor against side impact damage from the environment.

As disclosed in this application, the inventor has discovered novel and unique bottom guard devices for tractors that protect fuel tanks, hydraulic systems, electrical wiring and oil pans from physical damage while also providing additional stability to the tractor by lowering the center of gravity of the tractor.

As disclosed in the present application, the novel protection devices are not required to be removed from the underside of a tractor in order for the tractor owner or operator to service various vital equipment and components of the tractor.

Embodiments of the present invention provide for tractor bottom guard devices as described and defined in the description below and in the annexed claims which provide for improved safety, efficiency, and effectiveness characteristics in order to protect vital components of tractors.

### SUMMARY OF THE INVENTION

The following presents a simplified summary of the present disclosure in a simplified form as a prelude to the more detailed description that is presented herein.

Therefore, in accordance with embodiments of the invention, there is provided a tractor bottom guard device designed to safeguard the underside components of a tractor from potential damage during use and operation of the tractor.

The tractor bottom guard device includes a skid plate, preferably made of steel, that is designed to protect an underside of a tractor. The skid plate includes a planar member having a front end opposite a rear end and having a left side opposite a right side.

The bottom guard device is removably connected to a rear axle bracket, which is designed to removably connect to a rear axle of the tractor.

The rear end of the planar member extends upwards to form a transversal plate, which defines one or more traversal plate apertures, through which bolts respectively extend and secure the skid plate to the rear axle bracket.

In one embodiment, the transversal plate defines at least one transversal plate aperture through which at least one transversal bolt removably connects the skid plate to the rear axle bracket. In a preferred embodiment, the rear axle bracket is configured to removably connect to the rear axle of the tractor.

In one embodiment, the skid plate defines at least one draining aperture configured to provide access to an at least one OEM transmission fluid drain hole of the transmission of the tractor. In a preferred embodiment, the skid plate defines a plurality of draining apertures configured to provide access to respective OEM transmission fluid drain holes of the transmission of the tractor.

In a preferred embodiment, the 2-bolt transmission bracket is bolted to the transmission of the tractor with two bolts, by connecting to the OEM fabricated internally threaded bolt holes of the transmission of the tractor. In such embodiment, the two bolts connect the 2-bolt transmission bracket to the transmission of the tractor.

In yet another preferred embodiment, a pair of bolts removably connect the skid plate to the 2-bolt transmission bracket. The skid plate preferably defines two small access apertures that provide for access for tools of a user to tighten up the 2-bolt transmission bracket to the transmission of the tractor, as such access would otherwise be unavailable once the skid pate is mounted to the 2-bolt transmission bracket.

In yet another preferred embodiment, the tractor bottom guard device includes a 4-bolt transmission bracket.

In another embodiment, a plurality of bolts fastens the skid plate to a 4-bolt transmission bracket, and the 4-bolt transmission bracket is bolted to the transmission of the tractor. A plurality of apertures is disposed in the skid plate for accessing and tightening the 4-bolt transmission bracket to the transmission of the tractor.

In a preferred embodiment, the tractor bottom guard device includes a first corner bracket and a second corner bracket, and the first corner bracket and the second corner bracket are each removably connected to the underside frame of the tractor.

In a preferred embodiment, the tractor bottom guard device includes a first side shield which defines a first plurality of side shield apertures through which a respective plurality of bolts connects the first side shield to the first corner bracket of the tractor bottom guard device.

In another preferred embodiment, the tractor bottom guard device includes a second side shield that defines a second plurality of respective side shield apertures through which a respective plurality of bolts connects the second side shield to the second corner bracket of the tractor bottom guard device. The first side shield and the second side shield protect the fuel tank and hydraulics of the tractor against damage from impact with the environment during operations of the tractor.

In yet another embodiment, the tractor bottom guard device includes an engine belly pan that is removably connected to a skid plate bracket. The skid plate is also removably connected to the skid plate bracket, thereby providing a continuous connection between the engine belly pan and the skid plate. The skid plate bracket is configured to provide a continuous connection between the engine belly pan and the skid plate in order to prevent debris from the environment from impacting underside mechanical components that are vital to the operation and use of the tractor when in operation.

In a preferred embodiment, the installation process of the skid plate includes a plurality of steps, beginning with the removal of the tractor's wheel chocks, rear tires, and side steps. Next, the factory tool box bracket is preferably cut and removed from the tractor. The skid plate is then aligned and mounted to the tractor, with various brackets and bolts operatively fastened to secure the skid plate in place, as further detailed herein. Additional components including the engine belly pan, rear axle mounting bracket, and side shields are also installed as part of this process, each contributing to the comprehensive protection of the tractor's underside components that are vital to operation of the tractor.

These and other features, aspects, and advantages of the present invention will become better understood with reference to the following description and appended claims.

### BRIEF DESCRIPTION OF THE DRAWINGS

Illustrative embodiments of the present invention are described herein with reference to the accompanying drawings, in which:

FIG. 1A is a perspective view of a skid plate, in accordance with preferred embodiments of the invention;

FIG. 1B illustrates a rear, bottom side, perspective view of the skid plate as connected to a bottom (or underside) of an exemplary tractor, in accordance with embodiments of the invention;

FIG. 1C illustrates a rear, partially left, perspective view of the skid plate connected to a bottom (or underside) of an exemplary tractor, in accordance with embodiments of the invention;

FIG. 1D illustrates a front perspective view of the skid plate connected to a bottom (or underside) of an exemplary tractor and of an engine belly pan connected to the bottom (or underside) of the exemplary tractor, in accordance with embodiments of the invention;

FIG. 1E illustrates a bottom perspective view of a rear portion of the engine belly pan illustrated in FIG. 1D that is connected to the skid plate bracket of the tractor bottom guard device, to which the diagonal wall of the skid plate removably connects, in accordance with embodiments of the invention;

FIG. 2 illustrates a flow chart for installation of the skid plate of the tractor bottom guard device to an exemplary tractor, in accordance with embodiments of the invention;

FIG. 3A illustrates a side perspective view of portion of an exemplary loader bracket of a tractor with two exemplary factory bolts removed exposing two respective holes to which the engine belly pan is preferably connected, in accordance with embodiments of the invention;

FIG. 3B illustrates a side perspective view of the engine belly pan connected to the exemplary loader bracket of the tractor of FIG. 3A, in accordance with embodiments of the invention;

FIG. 4 provides a perspective view of a left side shield, in accordance with embodiments of the invention;

FIG. 5A illustrates a right side perspective view of the tractor bottom guard device, in accordance with embodiments of the invention;

FIG. 5B illustrates a left side perspective view of the tractor guard bottom guard device, in accordance with embodiments of the invention;

FIG. 6 illustrates a 2-bolt transmission bracket of the tractor bottom guard device as connected to an exemplary transmission of an exemplary tractor, in accordance with embodiments of the invention;

FIG. 7 illustrates a 4-bolt transmission bracket of the tractor bottom guard device as connected to an exemplary transmission of an exemplary tractor, in accordance with embodiments of the invention;

FIG. 8 illustrates a front left perspective view of a portion of the skid plate, the left side shield, and a tank guard connected to the left side shield, each removably connected to a front left corner guard bracket, in accordance with embodiments of the invention;

FIG. 9 illustrates exemplary OEM transmission fluid drain holes of an exemplary transmission of an exemplary tractor, in accordance with embodiments of the invention;

FIG. 10A illustrates another front left perspective view of a portion of the skid plate, the left side shield, and a tank guard connected to the left side shield, each removably connected to a front left corner guard bracket of the tractor bottom guard device, in accordance with embodiments of the invention;

FIG. 10B illustrates front right perspective view of a portion of the skid plate, the right side shield, and the tank guard connected to the right side shield, each removably connected to a front right corner guard bracket of the tractor bottom guard device, in accordance with embodiments of the invention;

FIG. 11A illustrates a rear, partially right side, perspective view of a rear axle bracket of the tractor bottom guard device as connected to an exemplary rear axle of the tractor (on the right-hand side of the tractor), in accordance with embodiments of the invention;

FIG. 11B illustrates a bottom rear perspective view of a rear axle bracket of the tractor bottom guard device as connected to an exemplary rear axle of the tractor (on the left-hand side of the tractor), in accordance with embodiments of the invention;

FIG. 12 illustrates a back, right side perspective view of a front right corner guard bracket of the tractor bottom guard device as connected to an exemplary tractor, in accordance with embodiments of the invention; and

FIG. 13 illustrates a right side perspective view of an exemplary cut-out of an exemplary OEM front loader bracket wherein the exemplary cut-out is adapted to receive therethrough a front top tab guard of the front right corner guard bracket of the tractor bottom guard device when connected to the exemplary tractor, in accordance with embodiments of the invention.

### DETAILED DESCRIPTION

For a further understanding of the nature and function of the embodiments, reference should be made to the following detailed description. Detailed descriptions of the embodiments are provided herein, as well as, the best mode of carrying out and employing the present invention. It will be readily appreciated that the embodiments are well adapted to carry out and obtain the ends and features mentioned as well as those inherent herein. It is to be understood, however, that the present invention may be embodied in various forms. Therefore, persons of ordinary skill in the art will realize that the following disclosure is illustrative only and not in any way limiting, as the specific details disclosed herein provide a basis for the claims and a representative basis for teaching to employ the present invention in virtually any appropriately detailed system, structure or manner. It should be understood that the devices, materials, methods, procedures, and techniques described herein are presently representative of various embodiments. Other embodiments of the disclosure will readily suggest themselves to such skilled persons having the benefit of this disclosure.

Reference will now be made in detail to the present preferred embodiments of the invention, examples of which are illustrated in the accompanying drawings. Wherever possible, the same reference numerals are used in the drawings and the description to refer to the same or like parts. As used and referenced herein, directional orientations, such as right side (or right-hand side) and left side (or left-hand side), refer to a directional orientation of a user or operator positioned in a driver's seat of a tractor (or inside a cab of a tractor) looking forward, such that references to a right side refer to a side of the tractor that is on the right-hand side of the user or operator, facing forward; and references to a left side refer to a side of the tractor that is on the left-hand side of a use or operator, facing forward. For purposes of clarity, by analogy, references to a right side refer to what would be considered the passenger side of a vehicle in the United States, and references to a left side refer to what would be considered a driver side of a vehicle in the United States.

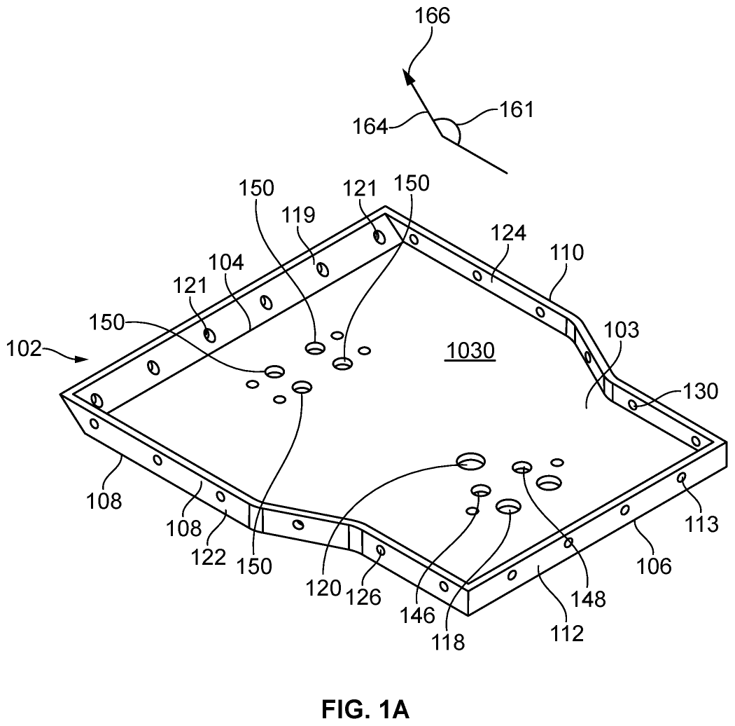

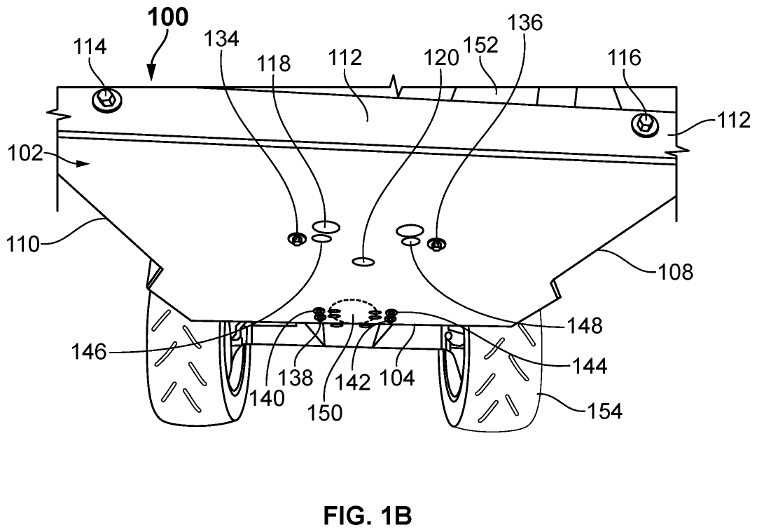

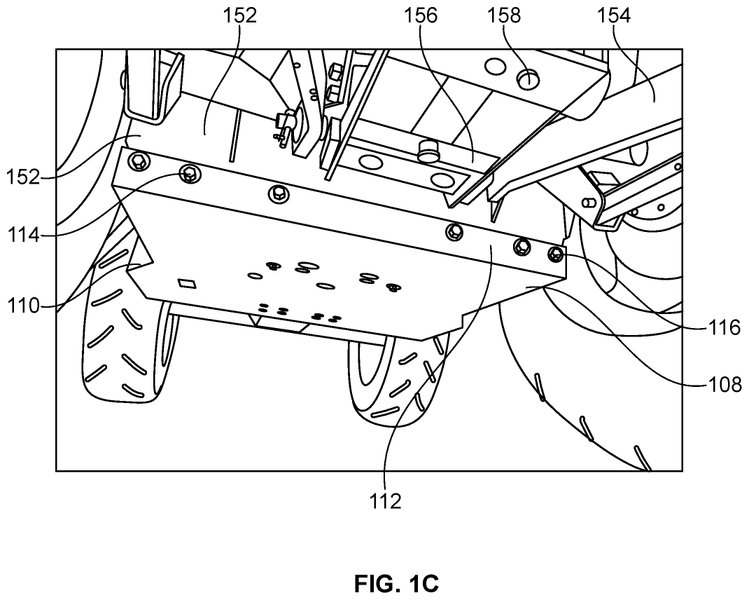

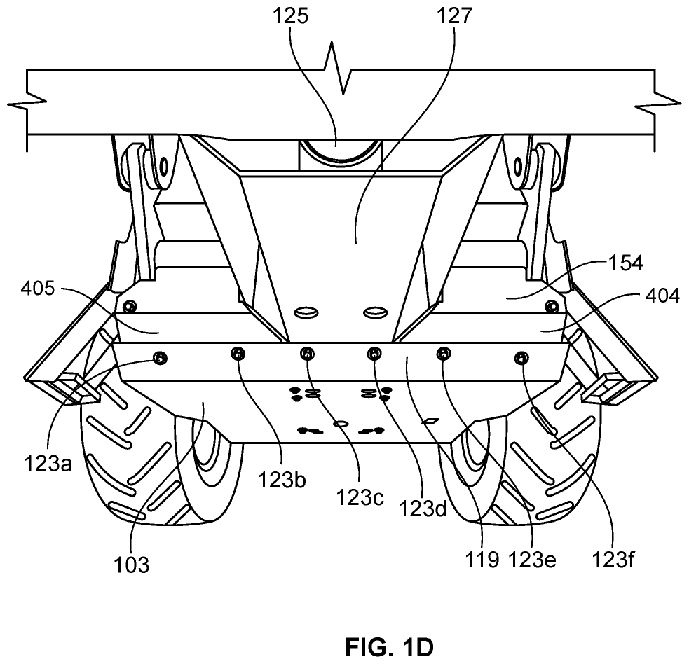

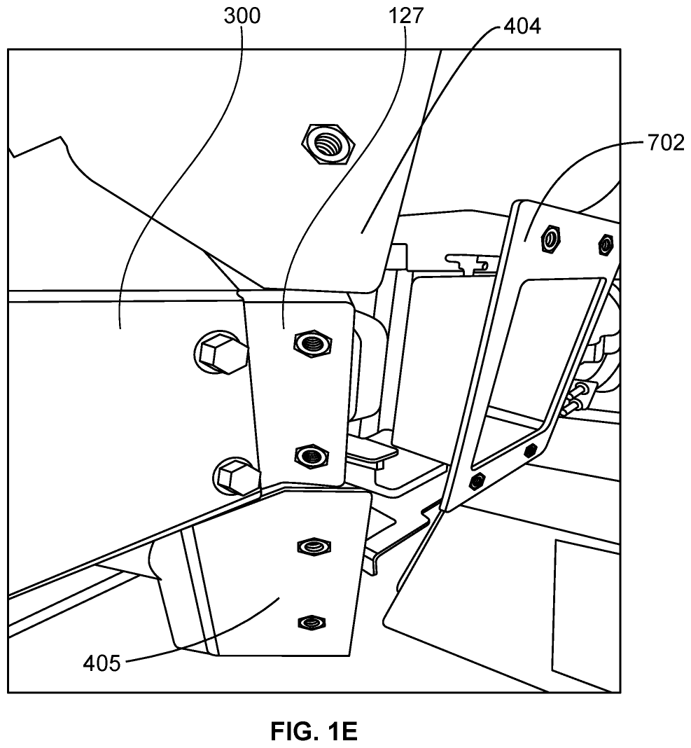

Referring to FIGS. 1A-1D, in a preferred embodiment, the disclosed tractor bottom guard device 100 includes a skid plate 102. The skid plate 102 is preferably made of steel and is removably connected to brackets that are configured to bolt to an underside 153 of the tractor 154 to protect the underside components 152 of the tractor 154. The skid plate 102 includes a planar member 103 extending between a front end 104 and a rear end 106. The planar member 103 has a left side 108 and an opposite right side 110, as exemplified in FIGS. 1A-1D.

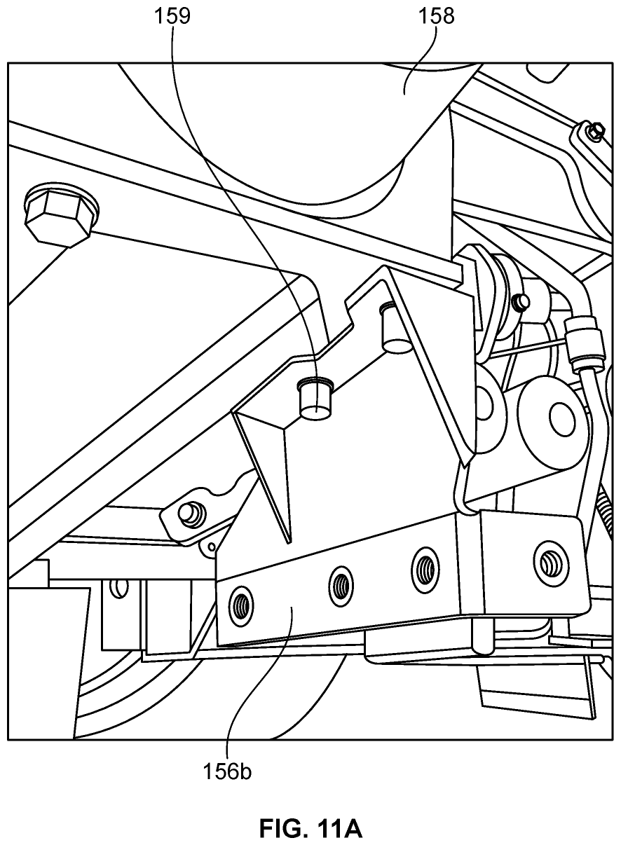

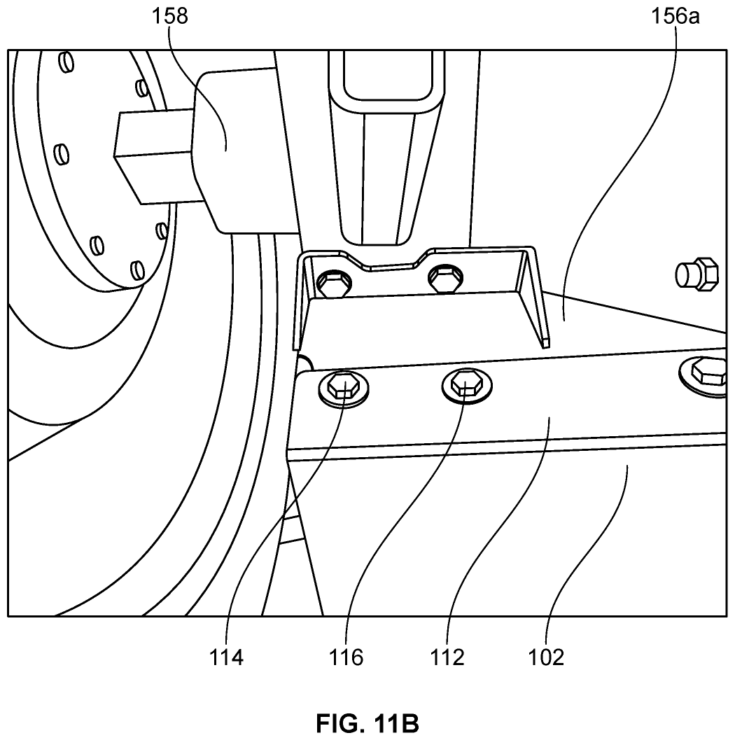

Referring to FIGS. 1A-1C, the rear end 106 of the planar member 103 of the skid plate 102 includes a transversal plate 112 extending upwards therefrom on a plane having an angle that is normal to a plane of the planar member 103. The transversal plate 112 defines at least one transversal plate aperture 113, as illustrated in FIG. 1A. One or more transversal plate bolts 114,116 extend through the at least one transversal plate aperture 113 (or transversal plate apertures, respectively) for removably connecting the skid plate 102 to a rear axle bracket 156, as illustrated in FIGS. 1B-1C. Further, the rear axle bracket 156 is adapted to removably connect to a rear axle 158 of the tractor 154 using the rear axle bolts 159, as illustrated in FIG. 11A.

Referring now to FIGS. 11A and 11B, the transversal plate 112 of the skid plate 102 is preferably fastened to the rear axle bracket 156 using the transversal plate bolts 114,116. The rear axle bracket 156 is removably connected to the rear axle 158 of the tractor 154 using the rear axle bolts 159.

The skid plate 102 defines at least a first draining aperture 118 (and preferably at least a second draining aperture 120) for providing access to at least one OEM transmission fluid drain hole 160 of the transmission 608 of the tractor 154, as illustrated in FIGS. 1A-1D. Preferably, the skid plate 102 defines at least a second draining aperture 120 configured to provide a user access through the skid plate 102 to an OEM transmission fluid drain hole 168 of the transmission 608 of the tractor 154.

In a preferred embodiment, the skid plate 102 includes a diagonal wall 119 disposed at the front end 104 of the planar member 103, and the diagonal wall 119 is preferably oriented at an angle 162, preferably at 150-degrees, that departs from a horizontal plane 1030 of the planar member 103, such that a plane 164 of the diagonal wall 119 extends upwards according to a ray 166 defined by said angle 150-degrees, as exemplified in FIG. 1A and FIG. 1D. The diagonal wall 119 defines a plurality of apertures 121 (FIG. 1A) through which a plurality of diagonal wall bolts 123 (e.g., 123a, 123b, 123c, 123d, 123e, 123f) extend, respectively, thereby removably connecting the skid plate 102 to the underside frame of the tractor.

As illustrated in FIG. 1D, preferably, two of the diagonal wall bolts 123c, 123d of the plurality of diagonal wall bolts 123 connect a rear portion of the engine belly pan 300 to the skid plate bracket 127, as illustrated in FIGS. 1D and 1E. The skid plate bracket 127 provides a continuous connection between the engine belly pan 300 and the skid plate 102, thereby preventing debris from the environment to impact or otherwise damage the mechanical components 152 of the tractor 154. In other words, the skid plate bracket 127 closes an otherwise gap between the rear portion of the engine belly pan 300 and the diagonal wall 119 of the skid plate 102.

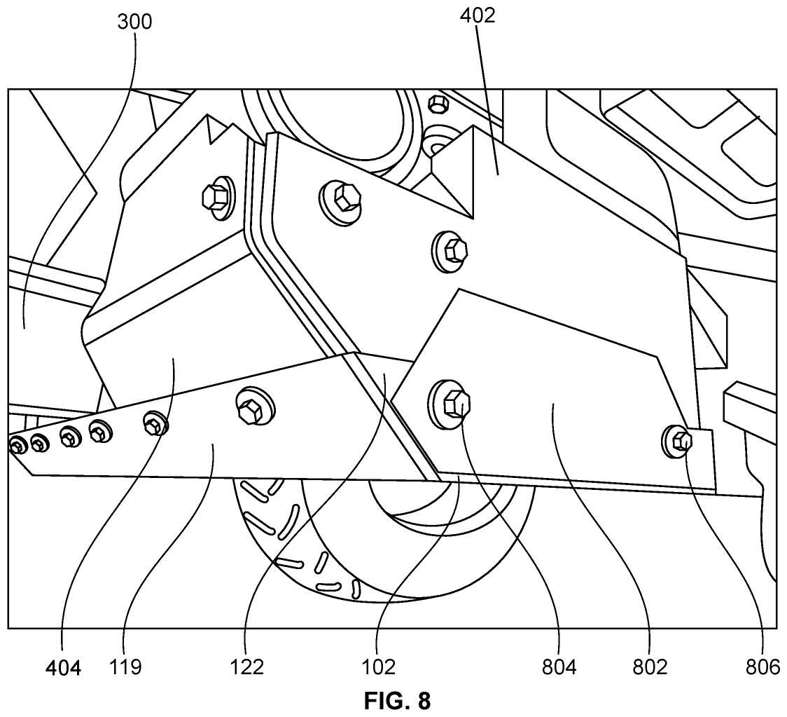

In a preferred embodiment, two of the diagonal wall bolts 123a, 123b of the plurality of diagonal wall bolts 123 connect the diagonal wall 119 of the skid plate 102 to the front right corner guard bracket 405 of the tractor bottom guard device 100. Preferably, two of the diagonal wall bolts 123e, 123f of the plurality of diagonal wall bolts 123 connect the diagonal wall 119 of the skid plate 102 to the front left corner guard bracket 404, as illustrated in FIG. 1D and FIG. 8. As can be appreciated from the disclosure herein, through embodiments of the invention disclosed invention, the skid plate 102 is removably connected to the tractor 154.

In a preferred embodiment, the skid plate 102 includes a first vertical wall 122 disposed at the left side 108 of the planar member 103, and the skid plate 102 includes a second vertical wall 124 disposed at the right side 110 of the planar member 103. The first vertical wall 122 is preferably disposed and oriented at an angle that is perpendicular to a horizontal plane 1030 of the planar member 103. Similarly, the second vertical wall 124 is also preferably disposed and oriented at an angle that is perpendicular to the horizontal plane 1030 of the planar member 103.

Referring now to FIGS. 1A, 4 and 5, the first vertical wall 122 defines a plurality of apertures 126, through which a plurality of bolts 128 wherein respectively extend into brackets, which are connected to the underside 153 of the tractor 154 (as further detailed herein), thereby providing a removable connection of the skid plate 102 to the underside 153 of the tractor 154. Similarly, the second vertical wall 124 of the skid plate 102 also defines a respective plurality of apertures 130 through which a plurality of corresponding bolts 132 connect to brackets, further providing the removable connection of the skid plate 102 to the underside components 152 of the tractor 154.

The underside components 152 of the tractor 154 can include at least a transmission system, gear boxes, fuel tanks, fuel lines, oil pans, electrical wiring, and a hydraulic system including hydraulic lines, hydraulic gear pumps to generate pressure in the hydraulic system, or hydraulic cylinders (aka RAM cylinders) to transmit fluid from the piston to the hydraulic arm.

The skid plate 102 defines a pair of small apertures 146,148 for providing access to tighten up the 2-bolt transmission bracket 602 to the transmission 608 of the tractor using the bolts 610,611. From this disclosure, it will be appreciated by a person skilled in the art that the skid plate 102 is not required to be removed from the tractor 154 in order for a user to access and undertake necessary maintenance of the underside components 152 of the tractor.

In a preferred embodiment, the two bolts 134,136 are used for securely bolting the skid plate 102 to the 2-bolt transmission bracket 602, thereby preventing any lateral movement of the skid plate 102, relative to the tractor 154.

The skid plate 102 defines a plurality of apertures 150 for accessing and tightening up the 4-bolt transmission bracket 702 to the transmission 608 of the tractor 154. It will be appreciated by a person skilled in the art that the skid plate 102 is not required to be removed for accessing and tightening the skid plate 102.

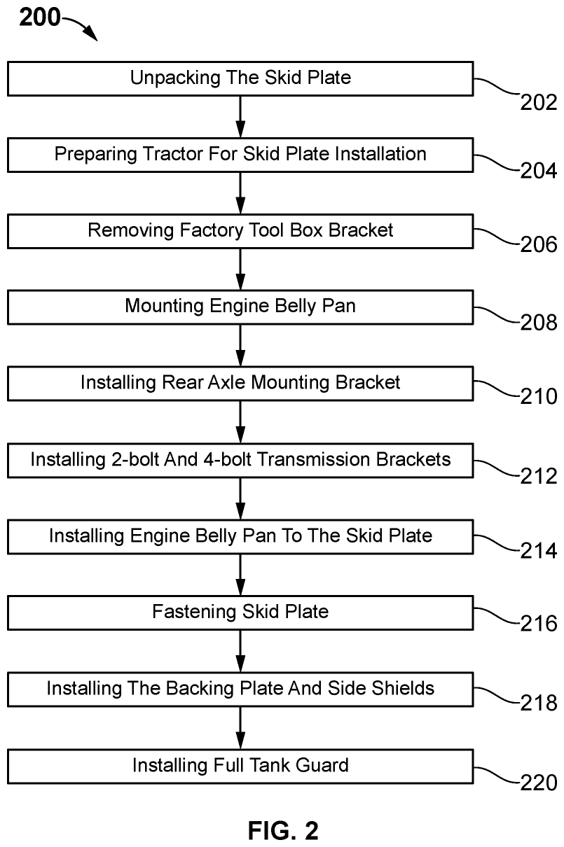

FIG. 2 illustrates a flow diagram depicting a process of installation of the skid plate that encloses the underside of the tractor and is configured to protect against physical impact critical and vital components of the tractor, in accordance with the embodiments disclosed herein. Initially, in step 202, the skid plate is taken out of the packaging along with all the bolts and brackets. In the next step 204, the tractor is prepared for installation of the skid plate 102. The wheel chocks on the front tires are removed and rear tires are removed as well along with side steps.

Thereafter, in step 206, the factory tool box bracket of the tractor 154 is preferably cut and removed using a tool such as a grinder. Thereafter, four bolts of the 4-bolt transmission bracket 702 and two bolts of the 2-bolt transmission bracket 602 are located on the bottom of the transmission and debris is removed. Then, in step 208, the loader bracket is loosened and engine belly pan 300 is mounted and aligned with holes of the loader bracket.

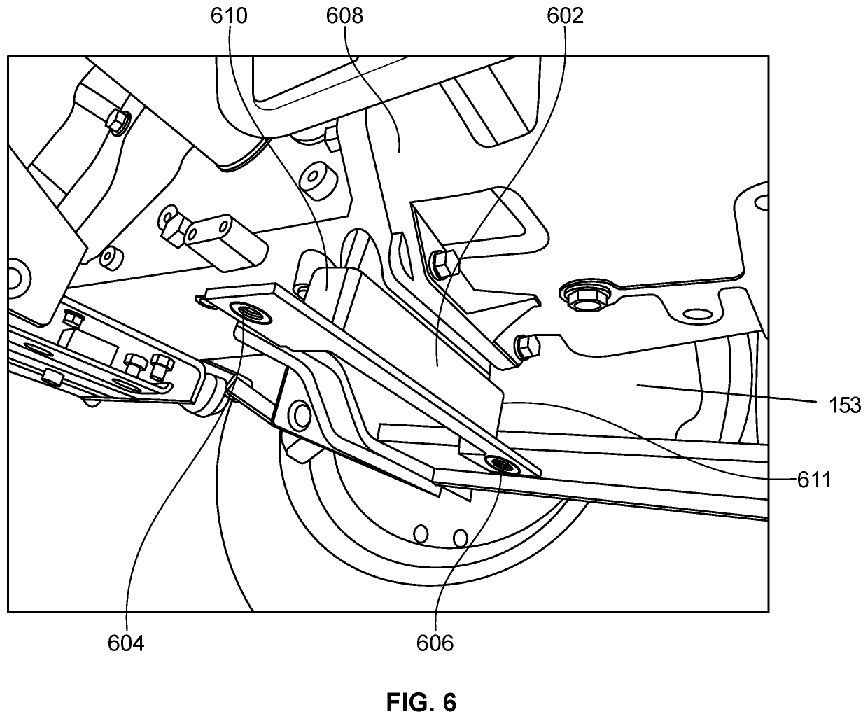

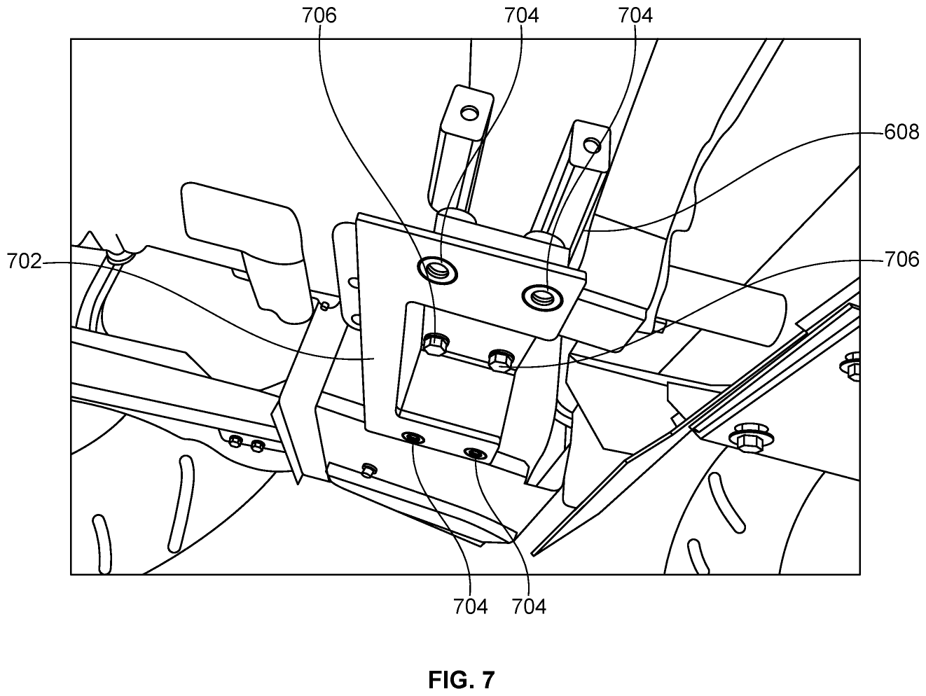

In the next step 210, the rear axle mounting brackets 156a, 156b are connected. Preferably, as detailed herein, bolts are used for operatively connecting the rear axle mounting brackets 156a, 156b and the skid plate 102. Then, in step 212, the 2-bolt transmission bracket 602 and 4-bolt transmission bracket 702 are disposed as described herein in relation to FIGS. 6-7.

Thereafter, the engine belly pan 300 is operatively connected to the skid plate bracket 127 in step 214. Then, in step 216, the skid plate 102 is mounted to the underside (frame) of the tractor 154. The bolts 138, 140, 142, 148 are tightened to removably connect (or fasten) the skid plate 102 to the 4-bolt transmission bracket 702. In addition, bolts 134, 136 are tightened to removably connect (or fasten) the skid plate 102 to the 2-bolt transmission bracket 602. In addition, bolts 114, 116 are tightened to removably connect (or fasten) the skid plate 102 to the rear axle mounting brackets 156 (156a).

Thereafter, in step 218, the side shields 402,403 are operatively connected to the skid plate 102 for shielding respective sides of the underside 153 of the tractor to protect the mechanical components 152 against damage from the environment when the tractor 154 is in use and operation. In step 220, in a preferred embodiment, a full tank guard 802 is operatively connected for the left side shield 402.

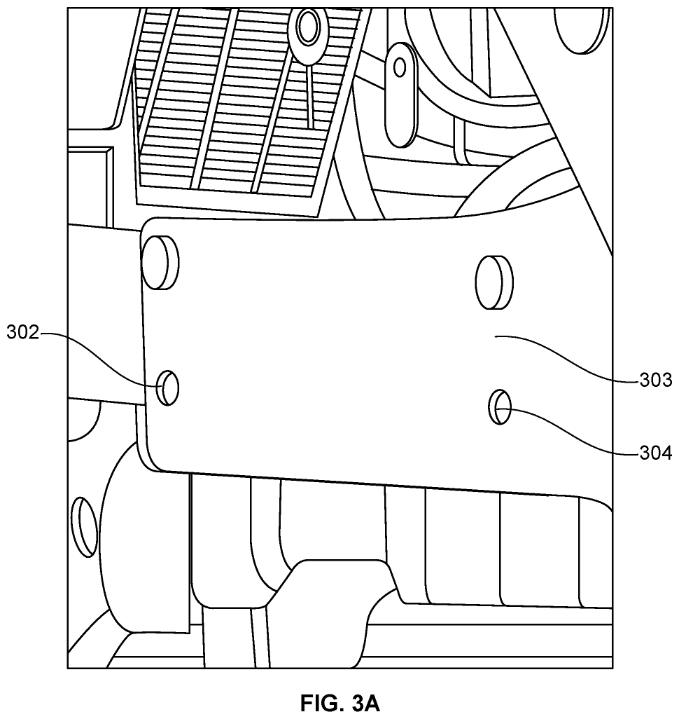

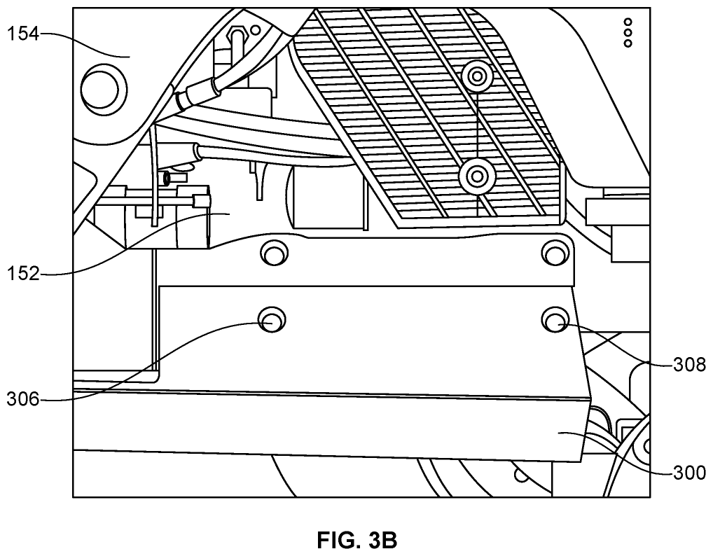

Referring now to FIGS. 3A and 3B, the engine belly pan 300 is mounted to the tractor 154 by removing the two bottom OEM factory bolts from the loader bracket 303 and exposing the OEM factory holes 302,304 defined by the loader bracket 303, as illustrated in FIG. 3A. Preferably, the engine belly pan 300 is connected to the tractor 154 by aligning its respective apertures with the OEM factory holes 302,304 of the loader bracket 303, and the engine belly pan 300 is bolted to the loader bracket 303 using the two bolts 306,308, as exemplified in FIG. 3B.

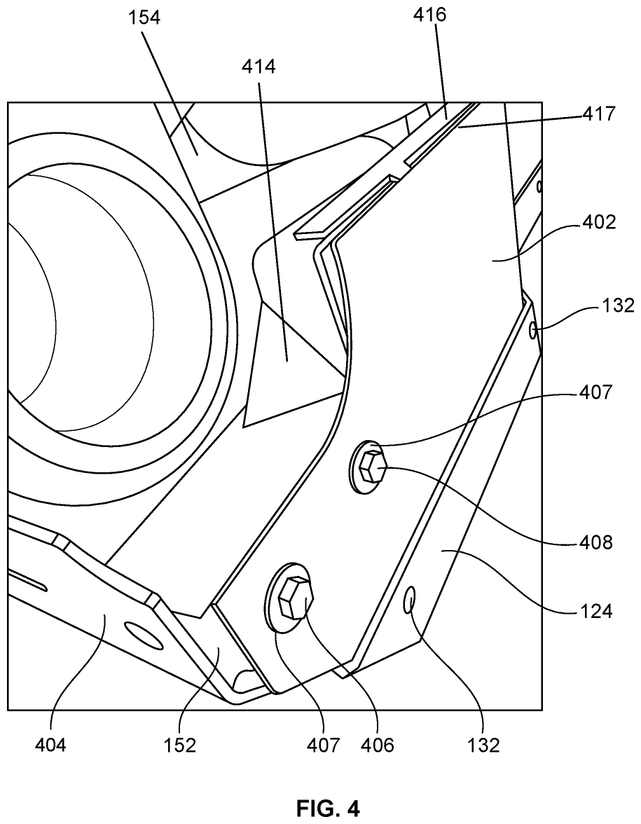

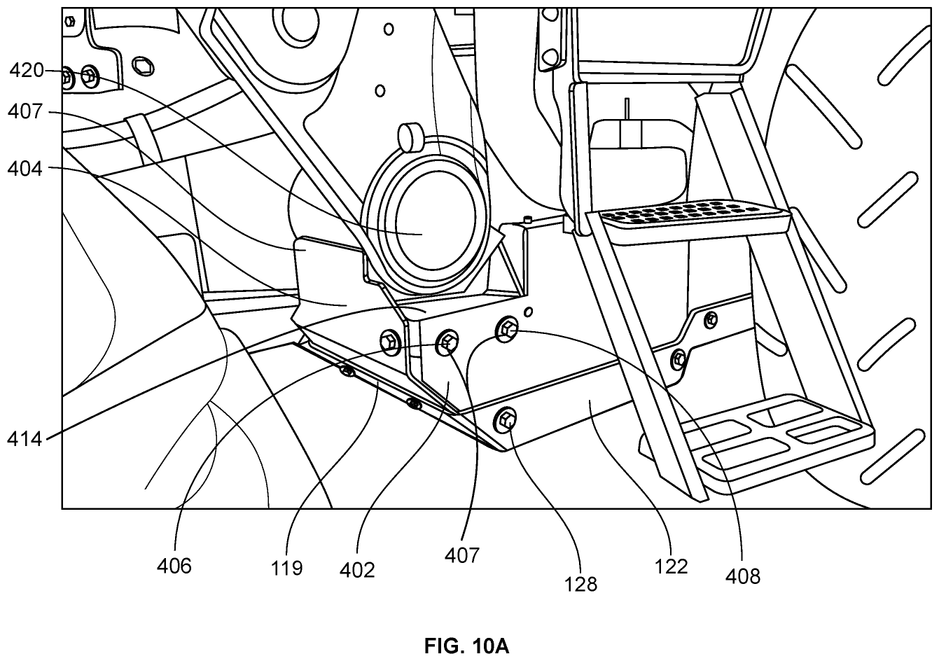

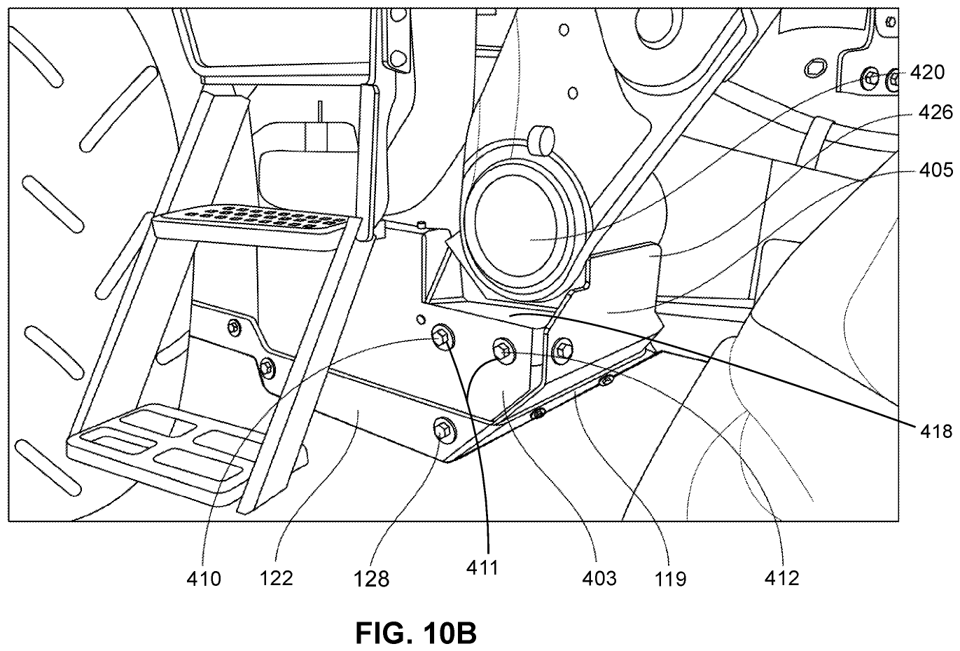

Referring now to FIGS. 4, 5A, 5B, 10A, and 10B, the exemplary side shields included in the tractor bottom guard device 100 of the present invention are shown in accordance with the disclosed structure. A left or first side shield 402 is disposed on the left side of the underside of the tractor, where the left or first side shield 402 is configured to protect the fuel tank and hydraulics of the tractor. The left side shield 402 is operatively connected using a first corner bracket 404 (also referred to herein and used interchangeably as the “front left corner guard bracket 404”). The left side shield 402 defines a plurality of first side shield apertures 407 through which preferably ½ inch bolts 406,408 extend therethrough thereby connecting the left side shield 402 to a front left corner cap 414, which is connected to the first corner bracket 404, as illustrated in FIG. 10A.

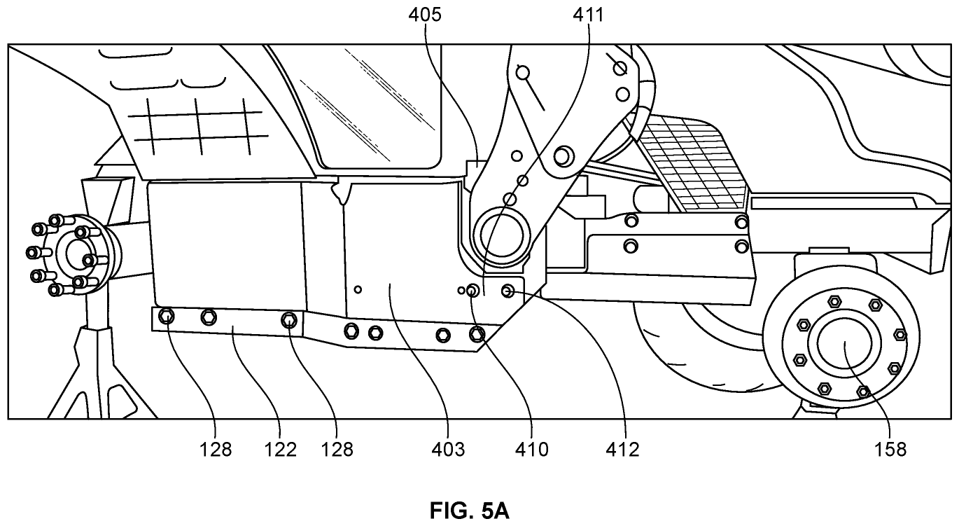

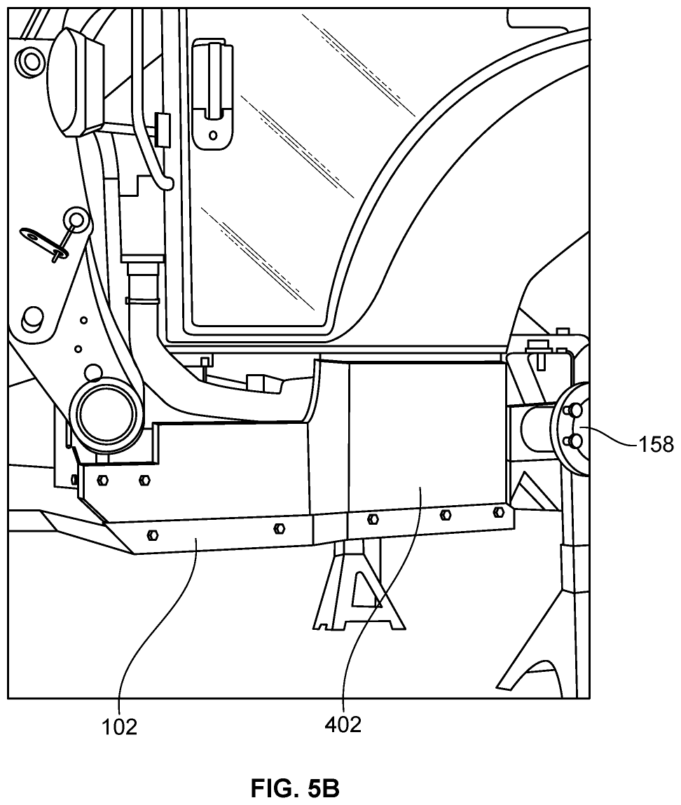

As illustrated in FIGS. 4 and 5B, the tractor bottom guard device 100 includes a front left corner guard bracket 404 that is configured to protect the underside components 152 of the tractor 154. The front left corner guard bracket 404 preferably includes a front top tab guard 407, as illustrated in FIG. 10A, adapted to provide further protection of the mechanical components 152 of the tractor 154 against damage from the environment. The skid plate 102 is preferably removably bolted to a front left corner guard bracket 404 of the tractor bottom guard device 100. It should be noted that, in a preferred embodiment, the tractor bottom guard device 100 includes a second corner bracket 405 (also referred to hercin and used interchangeably as the “front right corner guard bracket” 405), illustrated in FIG. 10B, which has a similar size, shape and configuration as the front left corner guard bracket 404, as illustrated in FIG. 10A.

As illustrated in FIG. 4, in a preferred embodiment, the left side shield 402 of the tractor bottom guard device 100 includes an elongated horizontal member 416 that extends inwardly (relative to the tractor 154) from the top edge 417 of the left side shield 402, where the elongated horizontal member 416 is configured to provide additional protection to the underside components 152 of the tractor 154.

Similarly, the second or right side shield 403 of the tractor bottom guard device 100 is removably connected to the right side of the underside frame of the tractor 154, where the second or right side shield 403 is configured to protect the fuel tank and hydraulics of the tractor 154. The right side shield 403 is preferably connected to a front right corner cap 418, which is connected to the second corner bracket 405 (also referred to herein and used interchangeably as the “front right corner guard bracket” 405) which is connected to the tractor 154, as exemplified in FIG. 10B.

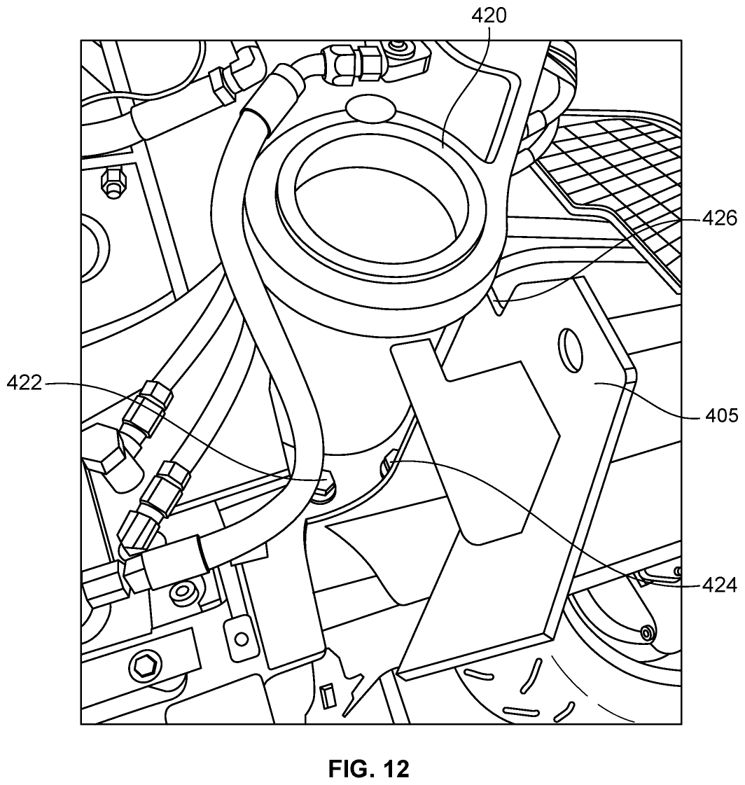

Referring to FIG. 10B and FIG. 12, the second side shield 403 defines a plurality of second side shield apertures 411 through which preferably ½ inch bolts 410,412 extend and connect the second side shield 403 to a front right corner cap 418, which is removably connected to the second corner bracket 405.

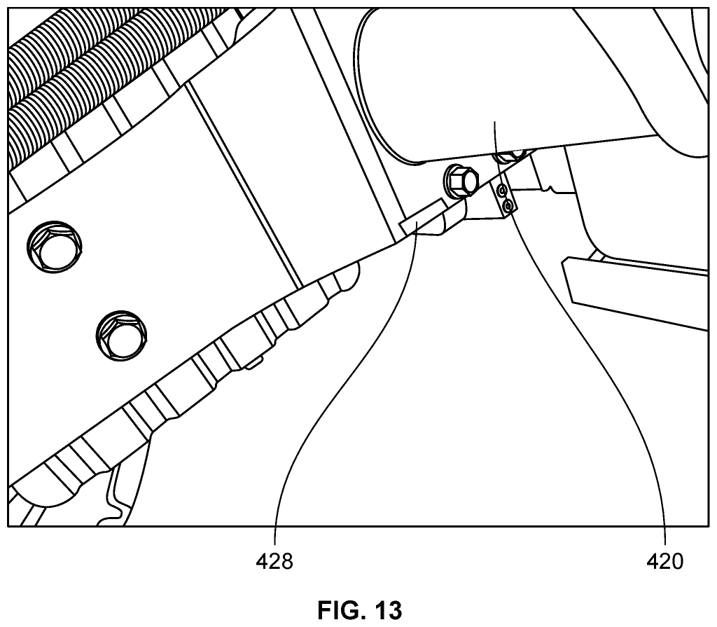

Referring to FIG. 12, the front right corner guard bracket 405 of the tractor bottom guard device 100 is preferably configured to be bolted to the bottom of the OEM factory loader bracket 420 of the tractor 154 using a pair of bolts 422,424. The front right corner guard bracket 405 preferably includes a front top tab guard 426, as illustrated in FIG. 10B, and the front right corner guard bracket 405 is configured to protect the hydraulics and fuel tank of the tractor 154 against damage from debris from the environment. The front top tab guard 426 preferably extends through a cut-out 428 in the front loader bracket 420, as illustrated in FIG. 13.

Now referring to FIGS. 6 and 7, the 2-bolt transmission bracket 602 and 4-bolt transmission bracket 702 of the tractor bottom guard device 100 are illustrated. The 2-bolt transmission bracket 602 (also referred to and used herein interchangeably as the “first transmission bracket” 602) defines at least a first bracket aperture 604,606 through which at least a first skid bracket bolt 134 and a second skid bracket bolt 136 respectively extend and removably connect the first transmission bracket 602 to the skid plate 102. The 2-bolt transmission bracket 602 is adapted to be removably connected to the transmission 608 of the tractor 154, and that removable connection is preferably undertaken with at least a first skid bracket transmission bolt 134.

The 4-bolt transmission bracket 702 (also referred to and used herein interchangeably as the “second transmission bracket” 702) defines second bracket apertures 704 through which at least four skid bracket bolts 138,140,142,144 respectively extend through the skid plate 102 thereby removably bolted the skid plate 102 to the second transmission bracket 702. The 4-bolt transmission bracket 702 is also adapted to removably connect to the transmission 608 using at least a second bolt 706.

Referring now to FIG. 8, the full tank guard 802 of the tractor bottom guard device 100 is bolted to the left side shield using ½ inch bolts and washers 804,806.

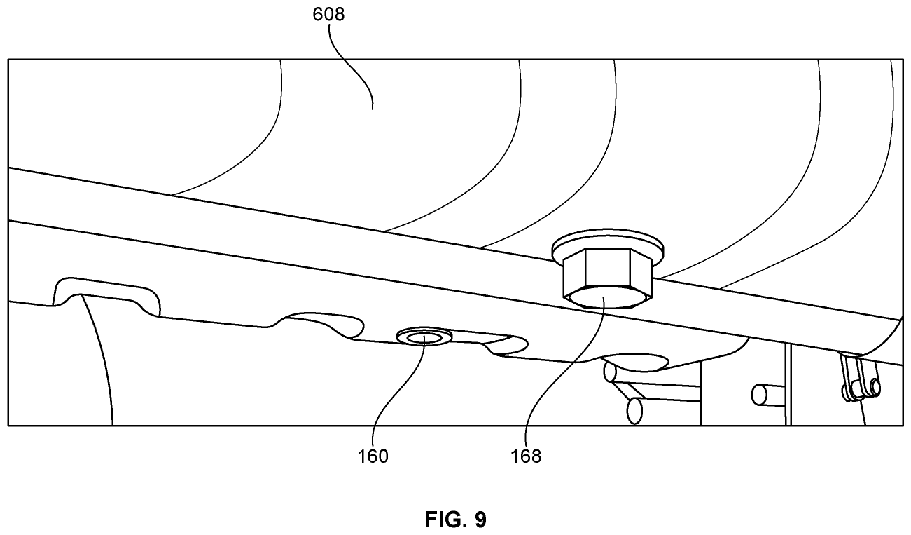

Referring now to FIG. 9, OEM transmission fluid drain holes 160,168 of the transmission 602 are displayed which can be accessed through the holes 118,120 of the tractor bottom guard device 100.

Except as may be expressly otherwise indicated, the article “a” or “an” if and as used herein is not intended to limit, and should not be construed as limiting, the description or a claim to a single element to which the article refers. Rather, the article “a” or “an” if and as used herein is intended to cover one or more such elements, unless the text expressly indicates otherwise.

This invention is susceptible to considerable variation within the spirit and scope of the appended claims.

The claimed invention is:

1. A tractor bottom guard device, comprising:
a skid plate adapted to protect underside components of a tractor, said skid plate comprising a planar member having a front end opposite a rear end, said planar member have a left side opposite a right side, said skid plate having a transversal plate extending upwards from the rear end at an angle normal to a plane of the planar member, the transversal plate defining at least one transversal plate aperture through which at least one transversal bolt removably connects the skid plate to at least a first rear axle bracket, said rear axle bracket adapted to removably connect to a rear axle of a tractor, said skid plate defining at least a first draining aperture configured to provide access to an OEM transmission fluid drain hole of the transmission of the tractor;
a first transmission bracket adapted to removably connect to the transmission of the tractor with at least a first bolt, said first transmission bracket defining at least a first bracket aperture through which at least a first skid bracket bolt removably connects the skid plate to said first transmission bracket; and
a second transmission bracket adapted to removably connect to the transmission of the tractor with at least a second bolt, said second transmission bracket defining at least a second bracket aperture through which at least a second skid bracket bolt removably connects the skid plate to said second transmission bracket.

2. The tractor bottom guard device of claim 1, said skid plate comprising a diagonal wall disposed at the front end of the planar member at an angle that departs from a horizontal plane of the planar member, such that a plane of the diagonal wall extends upwards according to a ray defined by said angle.

3. The tractor bottom guard device of claim 2, said skid plate comprising a first vertical wall and a second vertical wall, the first vertical wall disposed at the left side of the planar member at an angle that is perpendicular to the horizontal plane of the planar member, the second vertical wall disposed at the right side of the planar member at an angle that is perpendicular to the horizontal plane of the planar member.

4. The tractor bottom guard device of claim 3, wherein the first vertical wall and the second vertical wall each respectively define a plurality of apertures adapted to respectively receive a plurality of bolts configured for removable connection to an underside frame of the tractor.

5. The tractor bottom guard device of claim 2, wherein said skid plate defines at least a second draining aperture adapted to provide access through the skid plate to an OEM transmission fluid drain hole of the transmission of the tractor.

6. The tractor bottom guard device of claim 2, said first transmission bracket defining at least a second aperture through which at least a second skid bracket bolt removably connects the skid plate to said first transmission bracket.

7. The tractor bottom guard device of claim 2, said second transmission bracket defining at least four apertures through which at least four respective skid bracket bolts removably connect the skid plate to said second transmission bracket.

8. The tractor bottom guard device of claim 2, wherein said skid plate defines a first plurality of bolt access apertures configured to provide access through said skid plate for a user to tighten the bolts connecting the first transmission bracket to the transmission of the tractor.

9. The tractor bottom guard device of claim 8, wherein said skid plate defines a second plurality of bolt access apertures configured to provide access through said skid plate for a user to tighten the bolts connecting the second transmission bracket to the transmission of the tractor.

10. The tractor bottom guard device of claim 2, further comprising:
a first corner bracket and a second corner bracket, the first corner bracket and the second corner bracket each removably connected to an underside frame of the tractor; and
a first side shield and a second side shield, wherein the first side shield defines a first plurality of side shield apertures through which a respective plurality of bolts connect said first side shield to the first corner bracket, wherein the second side shield defines a second plurality of side shield apertures through which a respective plurality of bolts connect said second side shield to the second corner bracket, said first side shield and said second side shield configured to protect a fuel tank and hydraulics of the tractor against damage from impact with the environment during operations of the tractor.

11. The tractor bottom guard device of claim 10, further comprising:
an engine belly pan removably connected to a skid plate bracket, which is removably connected to the skid plate, said skid plate bracket configured to provide a continuous connection between the engine belly pan and the skid plate to prevent debris from the environment from impacting the underside mechanical components of the tractor.
